(19) United States
(12) Patent Application Publication
(10) Pub. No.: US 2013/0159934 A1
(43) Pub. Date: Jun. 20, 2013

(54) CHANGING IDLE SCREENS

(71) Applicant: KT Corporation, Gyeonggi-do (KR)

(72) Inventor: Ji-Eun KANG, Seoul (KR)

(73) Assignee: KT CORPORATION, Gyeonggi-do (KR)

(21) Appl. No.: 13/720,945

(22) Filed: Dec. 19, 2012

(30) Foreign Application Priority Data
Dec. 19, 2011 (KR) 10-2011-0137680

(51) Int. Cl. G06F 3/0482

(52) U.S. Cl. CPC G06F 3/0482
USPC 715/838; 715/810

(57) ABSTRACT

The disclosure is related to performing an idle screen change in a user terminal. One of a plurality of idle screens may be displayed. A user input for an idle screen change may be detected. An idle screen change procedure may be performed based on a predetermined idle screen change sequence when the user input is detected.

### CROSS REFERENCE TO PRIOR APPLICATIONS

The present application claims priority under 35 U.S.C. §119 to Korean Patent Application No. 10-2011-0137680 (filed on Dec. 19, 2011), which is hereby incorporated by reference in its entirety.

### FIELD OF THE INVENTION

The present invention relates to a mobile terminal and, in particular, to switching an idle screen using various gesture inputs.

### BACKGROUND OF THE INVENTION

An idle screen of a user terminal may be a graphic user interface displayed on a screen of the user terminal when the user terminal is in an idle status. Such an idle screen may be referred to as a standby screen. When an initialization process of the user terminal is finished after turning on the user terminal, the user terminal displays the idle screen with a variety of icons for mobile widgets and apps. For example, the mobile widget and/or the apps may include a clock widget, a calendar widget, weather widget, and a wallpaper widget.

Such an idle screen may be a starting and finishing point for all tasks associated with the user terminal. The idle screen may be a user interface which enables users to use various functions and features of the user terminal. The idle screen area may be easily extended beyond physical limits such as a screen size of a user terminal due to developments of a touch screen interface technique such as a screen flicking. Particularly, the user terminal may provide a plurality of idle screens (e.g., a first idle screen and a second idle screen). Each of the plurality of idle screens may be referred to as “an idle screen panel.” When the first idle screen is initially displayed in the user terminal, a user may switch the first idle screen to the second idle screen through a flicking gesture. Such a flicking gesture, however, may be recognized as a gesture input for invoking one of the widgets and apps displayed within the first idle screen.

### SUMMARY OF THE INVENTION

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, an idle screen change in a user terminal may be performed based on at least one of a predetermined idle screen change sequence and a user selection.

In accordance with an embodiment of the present invention, a method may be provided for performing an idle screen change operation in a user terminal. The method may include displaying one of a plurality of idle screens, detecting a user input for changing an idle screen, and performing an idle screen change procedure based on a predetermined idle screen change sequence and the detected user input.

The method may further include displaying virtual layer recognition image indicating information associated with the plurality of idle screens.

The virtual layer recognition image may be configured in one of a dog-eared type, a stack type, and an overlapping type.

The virtual layer recognition image configured in the stack type may indicate at least one of the number of idle screens, and layer information on a currently displayed idle screen.

The virtual layer recognition image in the overlapping type may be formed by overlapping an uppermost idle screen including an active region displayed in a non-transparent type and an inactive region displayed in a transparent type, and at least one idle screen excluding the uppermost idle screen, displayed in a semi-transparent type.

The detecting may detect one of at least a touch input on at least a portion of the virtual layer recognition image, a shaking input, and a key input.

The detecting may include determining whether the detected user input satisfies a predetermined reference input condition for the idle screen change.

The predetermined idle screen change sequence may be determined based on a user preference.

The performing may include determining a next idle screen to be displayed, based on the predetermined idle screen change sequence when the user input is detected; and displaying the determined next idle screen in place of a currently displayed idle screen.

In accordance with another embodiment of the present invention, a method may be provided for performing an idle screen change operation based on a user selection in a user terminal. The method may include displaying one of a plurality of idle screens, detecting a user input for changing an idle screen, displaying an idle screen selection menu and the detected user input, receiving selection information from a user, and performing an idle screen change procedure from a currently displayed idle screen to a selected idle screen.

The user input may be one of a touch input, a shaking input, and a key input.

The method may further include displaying a virtual layer recognition image associated with the plurality of idle screens.

The virtual layer recognition image may be configured as a stack type.

The displaying an idle screen selection menu may include detecting the touch input on at least a portion of the virtual layer recognition image, and displaying the idle screen selection menu based on the detected touch input.

The detecting may include determining whether the detected user input satisfies a predetermined reference input condition for the idle screen change.

The idle screen selection menu may include at least one idle screen image arranged in a card array type.

The idle screen selection menu may include a stack image configured to be based on virtual layers and to indicate a virtual layer corresponding to a currently displayed idle screen, and a thumbnail image of the currently displayed idle screen.

In accordance with still another embodiment of the present invention, an apparatus may be provided for performing an idle screen change operation. The apparatus may include a user input detection unit and an idle screen change unit. The user input detection unit may be configured to detect a user input for changing an idle screen. The idle screen change unit may be configured to perform an idle screen change procedure based on at least one of predetermined idle screen change sequence and user selection information.

The idle screen change unit may be configured to provide a virtual layer recognition image indicating information associated with the plurality of idle screens, and to perform the idle screen change procedure based on the predetermined idle screen change sequence when the user input is detected.

The idle screen change unit may be configured to provide an idle screen selection menu when the user input is detected, to obtain user selection information, and to perform the idle screen change procedure from a currently displayed idle screen to a next idle screen corresponding to the user selection information.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates performing a typical idle screen change procedure;

FIG. 2 illustrates a relationship between an idle screen and a virtual layer in accordance with at least one embodiment of the present invention;

FIG. 3 illustrates an apparatus for performing an idle screen change in accordance with at least one embodiment of the present invention;

FIG. 4 illustrates performing an idle screen change based on a predetermined idle screen change sequence in a user terminal in accordance with at least one embodiment of the present invention;

FIG. 5 illustrates performing a virtual layer recognition image creation procedure in a user terminal in accordance with at least one embodiment of the present invention;

FIG. 6A illustrates a virtual layer recognition image configured in a dog-eared type in accordance with at least one embodiment of the present invention;

FIG. 6B illustrates a virtual layer recognition image configured in a stack type in accordance with at least one embodiment of the present invention;

FIG. 6C illustrates a virtual layer recognition image configured in an overlapping type in accordance with at least one embodiment of the present invention;

FIG. 7 illustrates performing an idle screen change based on a user selection in a user terminal in accordance with at least one embodiment of the present invention;

FIG. 8A illustrates an idle screen selection menu configured in a card array type in accordance with at least one embodiment of the present invention; and

FIG. 8B illustrates an idle screen selection menu configured in a stack type in accordance with at least one embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

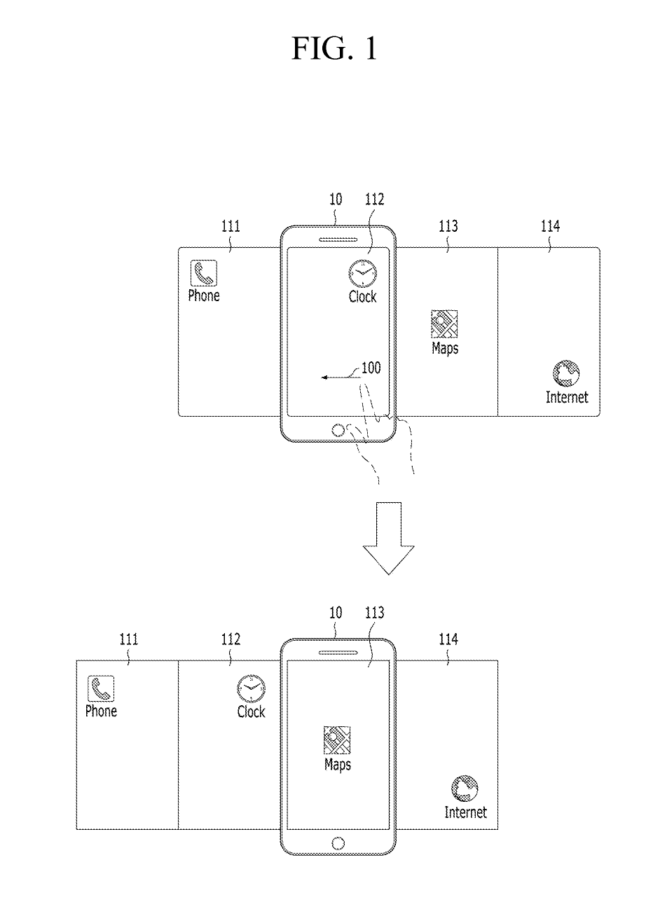

FIG. 1 illustrates a typical idle screen change procedure.

As shown in FIG. 1, user terminal 10 may provide a plurality of idle screens such as idle screen 111 to idle screen 114. Herein, the term “idle screen” used with respect to idle screens 111 to 114 may be referred to as “idle screen panel(s).”

When idle screen 112 is displayed on a display unit of user terminal 10, a user may change idle screen 112 to idle screen 113 through flicking gesture 100. User terminal 10, however, may recognize the flicking gesture 100 as a gesture input for invoking one of icons such as a widget icon and an app icon displayed within first idle screen.

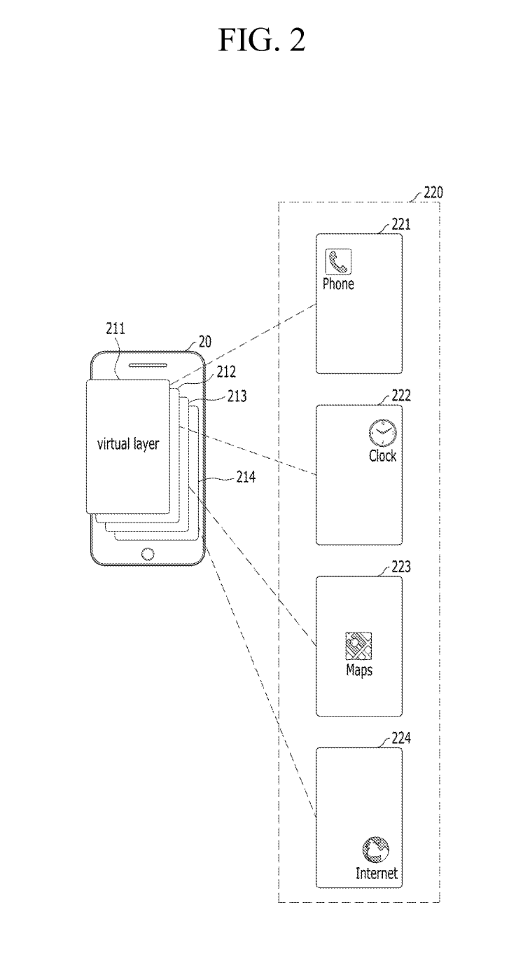

In order to overcome such disadvantages of a typical idle screen change procedure using a flicking gesture, an idle screen change operation may be performed according to at least one of a predetermined idle screen change sequence and a user selection in accordance with at least one embodiment of the present invention. Further, an idle screen change procedure may provide at least one of a virtual layer recognition image and an idle screen selection menu based on a virtual layer concept. A method and an apparatus may be provided for performing an idle screen change procedure based on a predetermined idle screen change sequence and/or a user selection in accordance with at least one embodiment of the present invention. Such a method and an apparatus will be described with reference to FIG. 2 to FIG. 8B.

FIG. 2 illustrates a correspondent relationship between an idle screen and a virtual layer in accordance with at least one embodiment of the present invention.

As illustrated in FIG. 2, an idle screen change operation in user terminal 20 in accordance with at least one embodiment of the present invention may be performed based on a virtual layer concept. A plurality of idle screens to be displayed on a display unit of user terminal 20 may respectively correspond to a plurality of virtual layers formed in a stack type structure. For example, when there are four idle screens 220 (221 to 224) to be displayed in user terminal 20, idle screen 221 to idle screen 224 may respectively correspond to virtual layer 211 to virtual layer 214. That is, a correspondent relationship (i.e., a mapping relationship) exists between virtual layers 211 to 214 and idle screens 221 to 224.

Herein, the term “virtual layer” is not necessarily a concept representing an idle screen structure where idle screens are displayed in a stack type structure. In at least one embodiment of the present invention, the virtual layer might be a concept used to perform an idle screen change procedure under the condition that idle screens to be displayed are arranged in a specific structure such as with a stack type structure, but other structures are possible. Herein, the specific structure may include an idle screen change sequence. Also, the idle screen change sequence may be referred to as an idle screen display sequence or a virtual stack sequence of idle screens. Accordingly, the idle screen change procedure may be performed based on the idle screen change sequence.

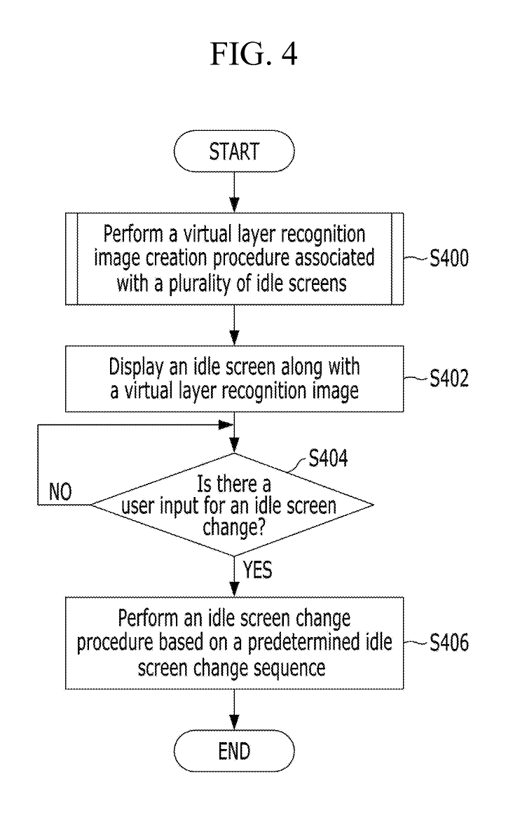

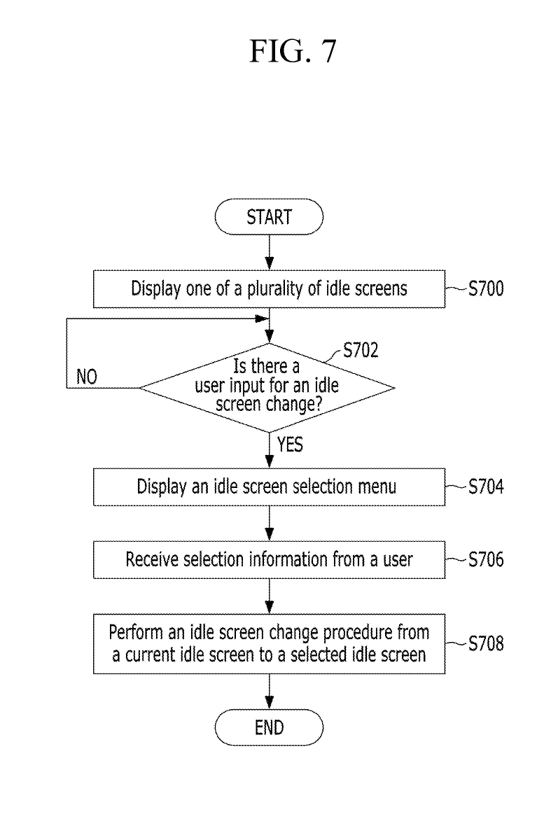

For example, an idle screen (e.g., idle screen 221) of the uppermost virtual layer (e.g., virtual layer 211) may have a highest priority with respect to a display sequence. Accordingly, user terminal 20 may initially display idle screen 221 and perform an idle screen change procedure from idle screen 221 to one of idle screens 222 through 224 according to at least one of a predetermined change sequence (such as in reference to FIG. 4) and a user selection (such as in reference to FIG. 7). For this reason, idle screen 221 corresponding to the uppermost virtual layer (e.g., virtual layer 211) may be referred to as “a base idle screen.” Idle screen 222 to idle screen 224 may be referred to as “extended idle screen(s).”

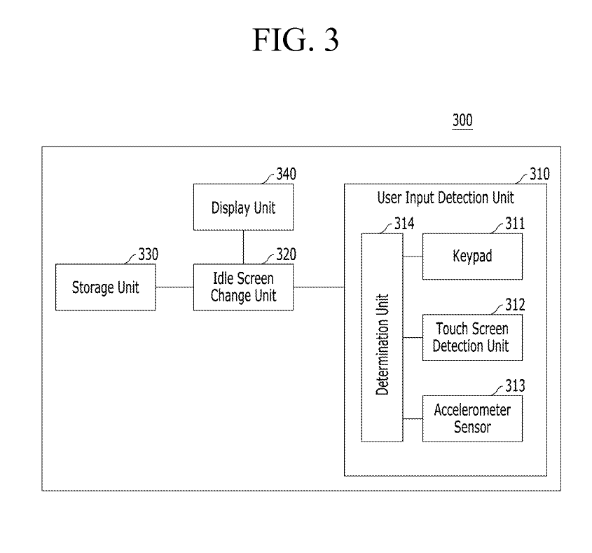

FIG. 3 illustrates an apparatus for performing an idle screen change operation in accordance with at least one embodiment of the present invention.

The apparatus may be illustrated as an independent apparatus in FIG. 3, but the present invention is not limited thereto. For example, the apparatus may be included in user terminal 20. Herein, user terminal 20 may be a user device which is capable of displaying an idle screen. Such user terminal 20 may be, but not limited to, a mobile station (MS), a mobile terminal (MT), a wireless terminal, a smart phone, a cell-phone, a personal digital assistant (PDA), a portable multimedia player (PMP), a wireless communication device, a portable device, a laptop computer, a desktop computer, a digital television, a digital broadcasting terminal, a navigation device, and so forth.

As illustrated in FIG. 3, apparatus 300 may include user input detection unit 310, idle screen change unit 320, storage unit 330, and display unit 340 in accordance with at least one embodiment of the present invention.

User input detection unit 310 may detect a user input for an idle screen change operation (i.e., a user input requesting an idle screen change) and transmit an idle screen change event to idle screen change unit 320 based on a detection result. Herein, the user input for an idle screen change may include at least one of a key pad input, a touch screen input, and a shaking input by a user.

More specifically, user input detection unit 310 may include one or more of key pad 311, touch screen 312, and accelerometer sensor 313; and also so may include determination unit 314.

Key pad 311 may provide at least one key such that a user can input an operation command for an idle screen change. For example, the user's input for an idle screen change may be made by pressing a specific key (e.g., a direction key, a number key mapped to a movement direction, a menu key, a power switch key, a volume control key, etc.) on key pad 311.

Touch screen 312 may generate a corresponding input signal when a specific region on touch screen is pressed by the user. For example, the user's input for an idle screen change may be made by touching a corresponding screen region such as a virtual layer recognition image. In at least one embodiment of the present invention, key pad 311 may be implemented on touch screen 312.

Accelerometer sensor 313 may detect movement of user terminal 20 and generate movement data. Particularly, accelerometer sensor 313 may detect a shaking gesture when a user shakes user terminal 20.

Determination unit 314 may determine whether a user input detected through at least one of key pad 311, touch screen 312, and accelerometer sensor 313 satisfies a predetermined reference input condition (e.g., a user touch on a specific screen region, a specific key input, etc.) for an idle screen change. When the detected user input satisfies the predetermined reference input condition, determination unit 314 may recognize the detected user input as an idle screen change request, and then transmit the idle screen change event to idle screen change unit 320.

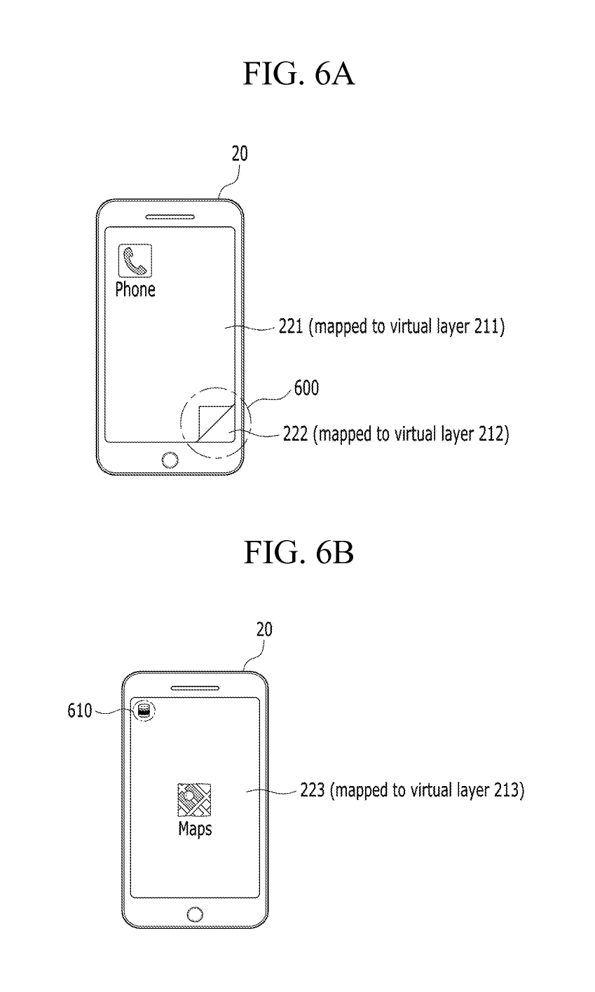

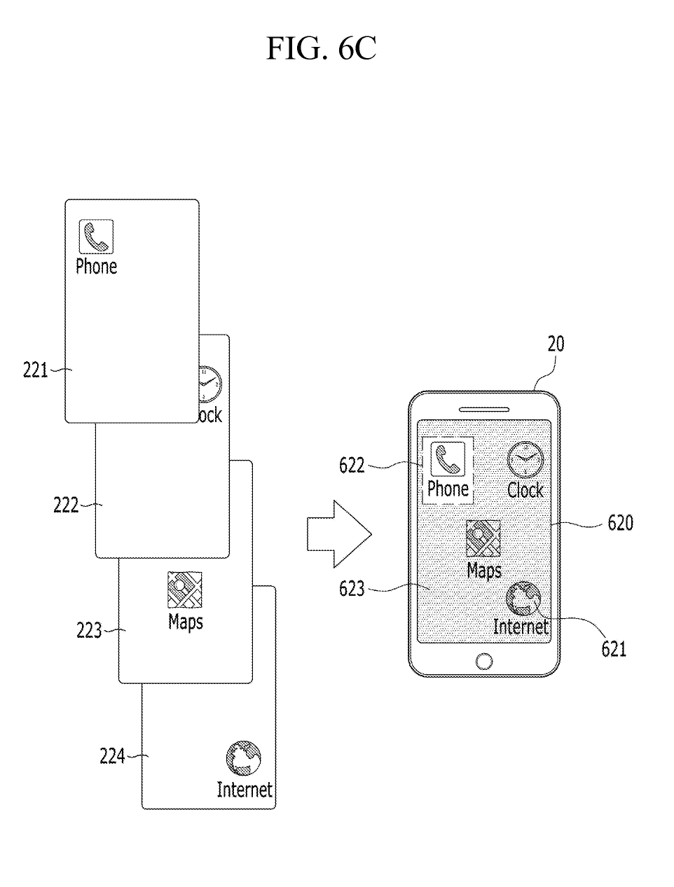

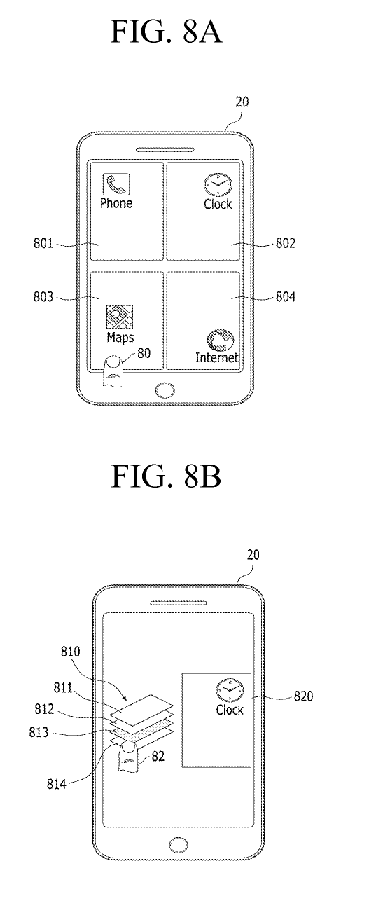

Idle screen change unit 320 may control user input detection unit 310, storage unit 330, and/or display unit 340 in connection with an idle screen change procedure. Particularly, idle screen change unit 320 may control display unit 340 to display one of the idle screen stored in storage unit 330. Further, idle screen change unit 320 may provide a virtual layer recognition image and/or an idle screen selection menu. The virtual layer recognition image will be described in more detail with reference to FIG. 6A to FIG. 6C. The idle screen selection menu will be described in more detail with reference to FIG. 8A and FIG. 8B.

Idle screen change unit 320 may perform an idle screen change procedure according to at least one of a predetermined idle screen change sequence (refer to FIG. 4) and a user selection (refer to FIG. 7) when receiving the idle screen change event from determination unit 314. Idle screen change unit 320 may determine a next idle screen based on the predetermined change sequence and/or the user selection and control display unit 340 such that the next idle screen is displayed in user terminal 20. The idle screen change procedure will be described in more detail with reference to FIG. 4 to FIG. 8B.

Storage unit 330 may store a plurality of idle screen corresponding to a plurality of virtual layers as shown in FIG. 2. Furthermore, storage unit 330 may store idle screen change sequence information, a virtual layer recognition image, a correspondent relationship between an idle screen and a virtual layer, and/or an idle screen selection menu.

Display unit 340 may display an idle screen determined by idle screen change unit 320. That is, display unit 340 may display a next idle screen determined by idle screen change unit 320.

FIG. 4 illustrates performing an idle screen change based on a predetermined idle screen change sequence in a user terminal in accordance with at least one embodiment of the present invention.

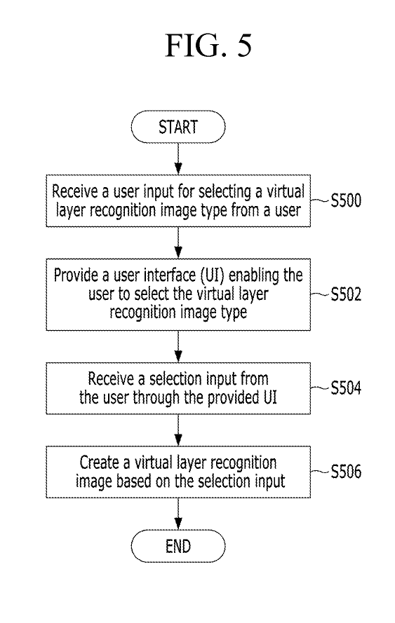

Referring to FIG. 4, user terminal 20 may perform a virtual layer recognition image creation procedure associated with a plurality of idle screens at step S400. For example, user terminal 20 may provide a variety of menu information such that a user can input preference information (e.g., a virtual layer recognition image type) associated with virtual layer recognition image creation. A virtual layer recognition image may be created based on the preference information (i.e., user selection information) input by a user. The virtual layer recognition image creation procedure will be described in more detail with reference to FIG. 5.

At step S402, user terminal 20 may initially display an uppermost layer idle screen (e.g., idle screen 221) along with a virtual layer recognition image. Herein, the virtual layer recognition image may be a sign image indicating that a plurality of idle screens are hidden under the initial idle screen, in a virtual layer stack structure. That is, such virtual layer recognition image may enable a user to recognize that a plurality of idle screens are hidden under the initial idle screen. For example, the virtual layer recognition image may be configured in one of a dog-eared type, a stack type, and an overlapping type. The dog-eared type, the stack type, and the overlapping type will be described in more detail with reference to FIG. 6A, FIG. 6B, and FIG. 6C, respectively.

At step S404, user terminal 20 may determine whether a user input is input for an idle screen change. More specifically, user terminal 20 may detect at least one of a key pad input, a touch screen input, and a shaking input by a user, in connection with the idle screen change. Upon the detection, user terminal 20 may determine whether the detected user input satisfies a predetermined reference input condition for an idle screen change. When the detected user input satisfies the predetermined reference input condition, user terminal 20 may recognize the detected user input as an idle screen change request.

With respect to the user input, the user key pad input may be made by pressing a specific key (e.g., a direction key, a number key mapped to a movement direction, a menu key, a power switch key, a volume control key, etc) on key pad 311. The user touch screen input may be made by touching a corresponding screen region such as a virtual layer recognition image. The user shaking input may be made by shaking user terminal 20.

At step S406, when detecting the user input for the idle screen change (Yes-S404), user terminal 20 may perform an idle screen change procedure according to a predetermined idle screen change sequence. More specifically, user terminal 20 may determine a next idle screen based on the predetermined idle screen change sequence and display the determined next idle screen in place of change a current idle screen (i.e., a currently displayed idle screen). For example, when a current idle screen (e.g., idle screen 221) mapped to “virtual layer 211” is being displayed, user terminal 20 may change the current idle screen to a next idle screen (e.g., idle screen 222) mapped to “virtual layer 212,” and then display the next idle screen. Further, user terminal 20 may repeatedly perform an idle screen change procedure according to a predetermined idle screen sequence whenever detecting the user input for the idle screen change.

FIG. 5 illustrates performing a virtual layer recognition image creation procedure in a user terminal in accordance with at least one embodiment of the present invention. Particularly, FIG. 5 illustrates performing the virtual layer recognition image creation procedure (S400) in user terminal 20.

Referring to FIG. 5, user terminal 20 may receive a user input for selecting a virtual layer recognition image type from a user at step S500. Herein, the user input for selecting a virtual layer recognition image type may be performed by at least one of a key pad input, a touch screen input, and a shaking input by a user.

At step S502, when receiving the user input for selecting a virtual layer recognition image type, user terminal 20 may provide a user interface (UI) enabling the user to select the virtual layer recognition image type. Herein, the UI for selecting the virtual layer recognition image type may provide a variety of virtual layer recognition image types in order to enable a user to select a desired virtual layer recognition image type. The virtual layer recognition image type may include at least one of a dog-eared type, a stack type, and an overlapping type. The dog-eared type, the stack type, and the overlapping type will be described in more detail with reference to FIG. 6A, FIG. 6B, and FIG. 6C, respectively.

At step S504, user terminal 20 may receive a selection input from the user through the provided UI. For example, the selection input may include type information on a virtual layer recognition image to be displayed in user terminal 20. Further, the selection input may include selection information on an idle screen change sequence. For example, a user may determine the idle screen change sequence based on a user preference as follows: idle screen 223 (“a base idle screen”)→idle screen 221 (“extended idle screen”)→idle screen 224 (“extended idle screen”)→idle screen 222 (“extended idle screen”). That is, idle screens 223, 221, 224, and 222 may respectively correspond to virtual layers 213, 211, 214, and 212.

At step S506, user terminal 20 may create a virtual layer recognition image based on the selection input. User terminal 20 may configure the virtual layer recognition image in at least one of the dog-eared type, the stack type, and the transparent/semi-transparent type. Herein, the configured the virtual layer recognition may reflect the idle screen change sequence determined by the user. When the user does not select the idle screen change sequence, user terminal 20 may apply a default change sequence.

FIG. 6A illustrates a virtual layer recognition image configured in a dog-eared type in accordance with at least one embodiment of the present invention.

Referring to FIG. 6A, user terminal 20 may display an idle screen (i.e., a current idle screen such as idle screen 221) mapped to the uppermost virtual layer (e.g., virtual layer 211) through display unit 340. Herein, the current idle screen (e.g., idle screen 221) may have virtual layer recognition image 600 which is configured in a dog-eared type at a bottom right region. Virtual layer recognition image 600 may show a portion of a next idle screen (e.g., idle screen 222 mapped to virtual layer 212).

When a user makes a touch gesture, such as a user finger tap or flick, on virtual layer recognition image 600, user terminal 20 may display a next idle screen mapped to a next virtual layer (e.g., virtual layer 212) in place of the current idle screen. For example, when a user taps virtual layer recognition image 600, user terminal 20 may display idle screen 222 corresponding to the next virtual layer. Herein, a tap gesture may represent a gesture that a user hits with his or her fingers lightly on at least a portion of the virtual layer recognition image 600. A flick gesture may represent a gesture that a user makes a currently displayed idle screen move away by hitting or pushing it quickly, especially with his or her finger.

Meanwhile, in at least one embodiment of the present invention, when the user presses (“a click”), or presses and holds (“a long click”) a specific hard key, user terminal 20 may display a next idle screen mapped to a next virtual layer (e.g., virtual layer 212) in place of the current idle screen. Herein, the specific hard key may be a preset key for an idle screen change such as a direction key, a number key mapped to a movement direction, a menu key, a power switch key, a volume control key, etc. The long click may represent a gesture that the user presses a specific key and holds it for a predetermined time.

Furthermore, in at least one embodiment of the present invention, when the user holds and shakes user terminal 20, user terminal 20 may display a next idle screen mapped to a next virtual layer (e.g., virtual layer 212) in place of a current idle screen.

The user's input operation for an idle screen change is not limited to the above-described input schemes. Furthermore, when a plurality of user input operations are sequentially performed, an idle screen change procedure may be performed based on a predetermined idle screen change sequence. In this case, whenever a user makes a touch gesture on virtual layer recognition image 600, user terminal 20 may sequentially change a current idle screen according to an idle screen change sequence (e.g., idle screen 221→idle screen 222→idle screen 223→idle screen 224).

FIG. 6B illustrates a virtual layer recognition image configured in a stack type in accordance with at least one embodiment of the present invention.

Referring to FIG. 6B, user terminal 20 may display an idle screen (i.e., a current idle screen such as idle screen 223) mapped to “virtual layer 213” through display unit 340 (FIG. 3). Herein, the current idle screen may have virtual layer recognition image 610 configured in a stack type at an upper left region.

The virtual layer recognition image 610 configured in a stack type may have the same number of layers as the number of virtual layers. Herein, the number of virtual layers may be identical to the number of idle screens which are capable of being displayed in user terminal 20. Further, a corresponding layer to a currently displayed idle screen may be highlighted in the virtual layer recognition image 610.

For example, as shown in FIG. 6B, when user terminal 20 displays an idle screen (i.e., a current idle screen such as idle screen 223) mapped to virtual layer 213, the third layer from the top in the virtual layer recognition image 610 may be highlighted such that a user can recognize the current idle screen. When a user makes a touch gesture, such as a user finger tap or flick, on the virtual layer recognition image 610, user terminal 20 may display a next idle screen mapped to a next virtual layer (e.g., virtual layer 214) in place of the current idle screen. When the user makes a touch gesture on the virtual layer recognition image 610, user terminal 20 may sequentially change a current idle screen according to an idle screen change sequence.

Meanwhile, in at least one embodiment of the present invention, when the user directly selects one layer of the virtual layer recognition image 610 through a touch gesture, user terminal 20 may display an idle screen corresponding to the selected layer.

In case of a virtual layer recognition image, such as virtual layer recognition image 610, configured in a stack type, when the user presses (“a click”), or presses and holds (“a long click”) a specific hard key, user terminal 20 may display a next idle screen mapped to a next virtual layer in place of a current idle screen. Furthermore, when the user holds and shakes user terminal 20, user terminal 20 may display a next idle screen mapped to a next virtual layer in place of a current idle screen. The user's input operation for an idle screen change is not limited to the above-described input schemes.

FIG. 6C illustrates a virtual layer recognition image configured in an overlapping type in accordance with at least one embodiment of the present invention.

For example, in the case that there are four idle screens (e.g., idle screen 221 to idle screen 224) to be displayed, user terminal 20 may display virtual layer recognition image 620 configured in an overlapping type as shown in FIG. 6C. User terminal 20 may display four idle screens 221 to 224 mapped to four virtual layers 211 to 214. Herein, an idle screen (e.g., idle screen 221) mapped to an uppermost virtual layer (e.g., virtual layer 211) may be displayed as a transparent type. Particularly, user terminal 20 may normally display an active element (e.g., screen region 622) of an idle screen (e.g., idle careen 221) mapped to an uppermost virtual layer (e.g., virtual layer 211), and transparently display the other region (“an inactive region”, 623) excluding the active element 622. Herein, the active element may be a function region, such as an icon region, which is capable of being activated by a user input (e.g., a touch input). Unlike this, idle screens (e.g., idle screen 212 to idle careen 214) mapped to virtual layers (e.g., virtual layer 212 to virtual layer 214) being under virtual layer 211 may be displayed in semi-transparent type.

All or some of the idle screens (e.g., idle screens 211, 212, 213, and/or 214) may be displayed on a terminal screen in an image overlapping manner. In this case, an entire idle screen 620 including all or some of the idle screens may be referred to as “the virtual layer recognition image configured in an overlapping type.” Herein, the overlapping type may be referred to as “a transparent/semi-transparent combination type.”

For example, in the case that idle screen 212 is an idle screen mapped to an uppermost virtual layer, active region 622 of idle screen 212 may be normally displayed, and inactive region 623 of idle screen 212 may be transparently displayed. Idle screen 212 to idle screen 214 may be semi-transparently displayed. Accordingly, when idle screen 211 to idle screen 214 are overlapped, an overlapping idle screen 620 may be referred to as a virtual layer recognition image. Idle screen 212 to idle screen 214 may be recognized through a shading portion 623 corresponding to a semi-transparent region.

In at least one embodiment of the present invention, when a user makes a touch gesture, such as a user finger tap or flick, on virtual layer recognition image 620 configured in an overlapping type, user terminal 20 may transparently display a next idle screen (e.g., idle screen 222) mapped to a next virtual layer (e.g., virtual layer 212 as a newly current idle screen) in place of the current idle screen (e.g., idle screen 221), and display the other idle screens (e.g., idle screens 223, 224, and 221) in semi-transparent type at the same time. Whenever the user makes a touch gesture on the virtual layer recognition image 620, user terminal 20 may sequentially change a current idle screen according to an idle screen change sequence (e.g., idle screen 221→idle screen 222→idle screen 223→idle screen 224). Herein, an idle screen corresponding to the current idle screen may be transparently displayed.

In at least one embodiment of the present invention, when the user directly selects one of the portions being displayed in a semi-transparent type in virtual layer recognition image 610 through a touch gesture, user terminal 20 may determine an idle screen corresponding to the selected portion as a next idle screen, and then transparently display the next idle screen. For example, when the user touches portion 621, user terminal 20 may determine idle screen 224 as a next idle screen. In this case, user terminal 20 may transparently display idle screen 224, and display the other idle screens (e.g., idle screen 221 to idle screen 223) in a semi-transparent type.

Meanwhile, in case of a virtual layer recognition image configured in an overlapping type, when the user presses (“a click”) or presses and holds (“a long click”) a specific hard key, user terminal 20 may transparently display a next idle screen mapped to a next virtual layer in place of a current idle screen. Furthermore, when the user holds and shakes user terminal 20, user terminal 20 may transparently display a next idle screen mapped to a next virtual layer in place of a current idle screen. The user's input operation for an idle screen change is not limited to the above-described input schemes.

FIG. 7 illustrates performing an idle screen change based on a user selection in a user terminal in accordance with at least one embodiment of the present invention.

Referring to FIG. 7, user terminal 20 may display one of a plurality of idle screens at step S700. For example, user terminal 20 may display a predetermined idle screen (e.g., an idle screen mapped to an uppermost virtual layer) during an idle mode. Further, user terminal 20 may display a virtual layer recognition image (e.g., a dog-eared type, a stack type image, etc.) associated with the plurality of idle screens, on a displayed idle screen. When seeing the virtual layer recognition image on the displayed idle screen, a user may recognize that a plurality of idle screens are hidden under the initial idle screen in a virtual layer stack structure.

At step S702, user terminal 20 may determine whether a user input is input for an idle screen change. More specifically, user terminal 20 may detect at least one of a key pad input, a touch screen input, and a shaking input by a user, in connection with the idle screen change. Upon the detection of the user input, user terminal 20 may determine whether the detected user input satisfies a predetermined reference input condition for an idle screen change. When the detected user input satisfies the predetermined reference input condition, user terminal 20 may recognize the detected user input as an idle screen change request.

With respect to the user input, the user key pad input may be made by pressing a specific key (e.g., a direction key, a number key mapped to a movement direction, a menu key, a power switch key, a volume control key, etc.) on key pad 311. The user touch screen input may be made by touching a corresponding screen region such as the virtual layer recognition image. The user shaking input may be made by shaking user terminal 20.

At step S704, when detecting the user input for the idle screen change (Yes-S702), user terminal 20 may display an idle screen selection menu. Herein, the idle screen selection menu may include information on the plurality of idle screens such that the user can select a desired idle screen. The idle screen selection menu will be described in more detail with reference to FIG. 8A and FIG. 8B.

When receiving selection information from the user at step S706, user terminal 20 may perform an idle screen change procedure from a current idle screen to a selected idle screen at step S708.

For example, when the user selects one of the idle screens presented by the idle screen selection menu, user terminal 20 may display the selected idle screen. Herein, a user input for an idle screen selection may be performed by at least one of a key pad input, a touch screen input, and a shaking input. For example, in the case that the idle screen selection menu is displayed, whenever the user shakes user terminal 20 once, a selection cursor of user terminal 20 may move from one idle screen to another idle screen. When the user shakes user terminal 20 twice within certain seconds, user terminal 20 may recognize the double shaking as a user selection.

FIG. 8A illustrates an idle screen selection menu configured in a card array type in accordance with at least one embodiment of the present invention.

As shown in FIG. 8A, the idle screen selection menu associated with idle screen 221 to idle screen 224 may be displayed in a card array type in user terminal 20. The idle screen selection menu may include demagnified images (e.g., image 801 to image 804) of idle screens 221 to 224.

When one of the demagnified images 801 to 804 is selected by a user, user terminal 20 may perform an idle screen change procedure. For example, when the demagnified image 803 is selected by a user touch input 80, user terminal 20 may display an original idle screen corresponding to the selected demagnified image 803.

FIG. 8B illustrates an idle screen selection menu configured in a stack type in accordance with at least one embodiment of the present invention.

As shown in FIG. 8B, the idle screen selection menu associated with idle screen 221 to idle screen 224 may be displayed in a stack type in user terminal 20. The idle screen selection menu may include stack image 810 of idle screens 221 to 224 and thumbnail image 820. Herein, stack image 810 may indicate that a plurality of idle screens to be displayed are hidden. For example, stack image 810 may indicate that four idle screens to be displayed are hidden in user terminal 20. Stack image 810 may also indicate that each of the four idle screens is mapped to each virtual layer as shown in FIG. 2. Each layer 811, 812, 813, or 814 of stack image 810 may correspond to each of idle screen 221 to idle screen 224.

Meanwhile, thumbnail image 820 may be a demagnified image of an idle screen corresponding to one of layers 811 to 814 of stack image 810. For example, thumbnail image 820 may be a demagnified image 820 of an idle screen corresponding to a highlighted layer 813 of stack image 810. Herein, highlighted layer 812 may represent a current idle screen.

In the case that the idle screen selection menu is displayed in user terminal 20, when a user makes touch gesture 82 on stack image 810, user terminal 20 may display a thumbnail image of a corresponding idle screen mapped to a next virtual layer. For example, in the case that thumbnail image 820 corresponding to layer 813 of stack image 810 is displayed, user terminal 20 may display a thumbnail image of a corresponding idle screen (e.g., idle screen 224) mapped to a next virtual layer (e.g., layer 814) in stack image 810 when a user taps stack image 810. Further, when the user repeatedly makes a plurality of touch gestures on stack image 810, user terminal 20 may display a corresponding thumbnail image based on a predetermined virtual layer sequence.

In at least one embodiment of the present invention, a specific layer portion (e.g., layer 814) of stack image 810 may be selected by a user touch input. In this case, user terminal 20 may display a thumbnail image corresponding to the selected layer (i.e., layer 814).

When a user selection operation using the screen selection menu is finished, user terminal 20 may display an idle screen corresponding to the selected idle screen through the user selection operation.

As described above, in accordance with at least one embodiment of the present invention, it is possible to provide a variety of idle screen services without giving any influence each other by performing an idle screen change procedure based on a virtual layer concept.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of performing an idle screen change operation in a user terminal, the method comprising:
displaying one of a plurality of idle screens;
detecting a user input for changing an idle screen; and
performing an idle screen change procedure based on a predetermined idle screen change sequence and the detected user input.

2. The method of claim 1, further comprising:
displaying virtual layer recognition image indicating information associated with the plurality of idle screens.

3. The method of claim 2, wherein the virtual layer recognition image is configured in one of a dog-eared type, a stack type, and an overlapping type.

4. The method of claim 3, wherein the virtual layer recognition image configured in the stack type indicates at least one of:
a number of idle screens; and
layer information on a currently displayed idle screen.

5. The method of claim 3, wherein the virtual layer recognition image in the overlapping type is formed by overlapping:
an uppermost idle screen including an active region displayed in a non-transparent type and an inactive region displayed in a transparent type; and
at least one idle screen excluding the uppermost idle screen, displayed in a semi-transparent type.

6. The method of claim 2, wherein the detecting detects one of at least a touch input on at least a portion of the virtual layer recognition image, a shaking input, and a key input.

7. The method of claim 2, the detecting includes:
determining whether the detected user input satisfies a predetermined reference input condition for the idle screen change.

8. The method of claim 1, wherein the predetermined idle screen change sequence is determined based on a user preference.

9. The method of claim 1, wherein the performing includes:
determining a next idle screen to be displayed, based on the predetermined idle screen change sequence when the user input is detected; and
displaying the determined next idle screen in place of a currently displayed idle screen.

10. A method of performing an idle screen change operation in a user terminal, the method comprising:
displaying one of a plurality of idle screens;
detecting a user input for changing an idle screen;
displaying an idle screen selection menu based on the detected user input;
receiving selection information from a user; and
performing an idle screen change procedure from a currently displayed idle screen to a selected idle screen.

11. The method of claim 10, wherein the user input is one of a touch input, a shaking input, and a key input.

12. The method of claim 11, further comprising:
displaying a virtual layer recognition image associated with the plurality of idle screens.

13. The method of claim 12, wherein the virtual layer recognition image is configured as a stack type.

14. The method of claim 13, wherein the displaying an idle screen selection menu includes:
detecting the touch input on at least a portion of the virtual layer recognition image; and
displaying the idle screen selection menu based on the detected touch input.

15. The method of claim 10, wherein the detecting includes:
determining whether the detected user input satisfies a predetermined reference input condition for the idle screen change.

16. The method of claim 10, wherein the idle screen selection menu includes at least one idle screen image arranged in a card array type.

17. The method of claim 10, wherein the idle screen selection menu includes:
a stack image configured to be based on virtual layers and to indicate a virtual layer corresponding to a currently displayed idle screen; and
a thumbnail image of the currently displayed idle screen.

18. An apparatus for performing an idle screen change operation, the apparatus comprising:
a user input detection unit configured to detect a user input for changing an idle screen; and
an idle screen change unit configured to perform an idle screen change procedure based on at least one of predetermined idle screen change sequence and user selection information.

19. The apparatus of claim 18, wherein the idle screen change unit is configured to:
provide a virtual layer recognition image indicating information associated with the plurality of idle screens; and
perform the idle screen change procedure based on the predetermined idle screen change sequence when the user input is detected.

20. The apparatus of claim 18, wherein the idle screen change unit is configured to:
provide an idle screen selection menu when the user input is detected;
obtain user selection information; and
perform the idle screen change procedure from a currently displayed idle screen to a next idle screen corresponding to the user selection information.
